(19) United States
(12) Patent Application Publication
(10) Pub. No.: US 2015/0011724 A1
(43) Pub. Date: Jan. 8, 2015

(54) METHOD FOR PRODUCING POLYMER

(71) Applicants: Taichi Nemoto, Shizuoka (JP); Chiaki Tanaka, Shizuoka (JP)

(72) Inventors: Taichi Nemoto, Shizuoka (JP); Chiaki Tanaka, Shizuoka (JP)

(21) Appl. No.: 14/373,693

(22) PCT Filed: Jan. 25, 2013
(86) PCT No.: PCT/JP2013/052295

§ 371 Date: Jul. 22, 2014

(30) Foreign Application Priority Data
Feb. 14, 2012 (JP) 2012-029293
Jul. 23, 2012 (JP) 2012-162602
Dec. 20, 2012 (JP) 2012-277712

(51) Int. Cl. C08G 63/08; C08G 63/82; C08G 64/30; C08G 63/78

(52) U.S. Cl. CPC C08G 63/08; C08G 63/78; C08G 63/823; C08G 64/30
USPC 528/274; 528/272; 528/354; 528/355

(57) ABSTRACT

A method for producing a polymer, including: (i) bringing a compressive fluid and raw materials containing a ring-opening polymerizable monomer into contact with each other at a mixing ratio represented by the following formula, to thereby allow the ring-opening polymerizable monomer to carry out ring-opening polymerization: 1>{Mass of the raw materials/(Mass of the raw materials+Mass of the compressive fluid)}≧0.5.

### TECHNICAL FIELD

The present invention relates to a method for producing a polymer through ring-opening polymerization of a ring-opening polymerizable monomer.

### BACKGROUND ART

Conventionally known methods for producing polymers involve ring-opening polymerization of a ring-opening polymerizable monomer. For example, disclosed is a method for producing polylactic acid by allowing a ring-opening polymerizable monomer and lactide to react for polymerization in a melted state (see PTL 1). In accordance with the disclosed method, lactide is reacted in a melted state to polymerize using tin octylate as a metal catalyst and setting the reaction temperature to 195° C.

In the case where polylactic acid is produced in this method, however, more than 2% by weight of lactide remains in a produced polymer product (see PTL 1). This is because an equilibrium relationship between the ring-opening polymerizable monomer and a polymer is established in a reaction system of ring-opening polymerization of polylactic acid or the like, and therefore a ring-opening polymerizable monomer tends to be generated by a depolymerization reaction, which is a reverse reaction of a ring-opening polymerization reaction, when it is polymerized at high temperature. The residual lactide acts as a catalyst for hydrolysis of the generated polymer product, or may impair thermal resistance of the polymer product.

As for a method for performing ring-opening polymerization of a ring-opening polymerizable monomer at low temperature, disclosed is a method for carrying out ring-opening polymerization of lactide in an organic solvent (see PTL 2). In accordance with the disclosed method, D-lactide is polymerized in a dichloromethane solution at 25° C., to thereby yield poly-D-lactic acid with the polymerization of the monomer being 99.4%. In the case where the polymerization is carried out in an organic solvent, however, it is necessary to provide a step for drying the organic solvent after the polymerization, and moreover it is difficult to completely remove the organic solvent from a produced polymer product even after the drying step.

As for a method for performing ring-opening polymerization of a ring-opening polymerizable monomer at low temperature without an organic solvent, disclosed is a method for polymerizing a ring-opening polymerizable monomer in a compressive fluid using an organic catalyst free from a metal atom (see PTL 3). In accordance with the disclosed method, a reaction vessel is charged with lactide, 4-pyrrolidinopyridine, and supercritical carbon dioxide (60° C., 10 MPa), and the mixture is allowed to react for 10 hours to yield polylactic acid.

### CITATION LIST

### Patent Literature

PTL 1: Japanese Patent Application Laid-Open (JP-A) No. 08-259676
PTL 2: JP-A No. 2009-001614
PTL 3: JP-A No. 2011-208115

### SUMMARY OF INVENTION

### Technical Problem

When a ring-opening polymerizable monomer is polymerized in a compressive fluid in accordance with the conventional production method, there has been a problem that a polymerization reaction requires a long time.

The present invention aims to solve the various problems in the art, and achieve the following object. An object of the present invention is to provide a method for producing a polymer, which shortens time required for a polymerization reaction compared to that in a case where a ring-opening polymerizable monomer is polymerized in a compressive fluid in accordance with the conventional production method.

### Solution to Problem

The method for producing a polymer of the present invention contains:

bringing a compressive fluid and raw materials containing a ring-opening polymerizable monomer into contact with each other at a mixing ratio represented by the following formula, to thereby allow the ring-opening polymerizable monomer to carry out ring-opening polymerization:

$$1 > \frac{Mass of the raw materials}{Mass of the raw materials + Mass of the compressive fluid} \geq 0.5$$

### Advantageous Effects of Invention

The present invention can solve the various problems in the art, achieve the aforementioned object, and provide a method for producing a polymer, which shortens time required for a polymerization reaction compared to that in a case where a ring-opening polymerizable monomer is polymerized in a compressive fluid in accordance with the conventional production method.

### BRIEF DESCRIPTION OF DRAWINGS

FIG. 1 is a general phase diagram depicting the state of a substance depending on pressure and temperature conditions.

FIG. 2 is a phase diagram which defines a compressive fluid used in the present embodiment.

FIG. 3 is a system diagram illustrating one example of a polymerization step used in the present embodiment.

### DESCRIPTION OF EMBODIMENTS

### (Method for Producing Polymer)

One embodiment of the present invention will be specifically explained hereinafter.

The method for producing a polymer of the present embodiment contains at least a polymerization step, and may further contain appropriately selected other steps.

### <Polymerization Step>

The polymerization step contains bringing a compressive fluid and raw materials containing a ring-opening polymerizable monomer into contact with each other at a mixing ratio represented by the following formula, to thereby allow the ring-opening polymerizable monomer to carry out ring-opening polymerization.

$$1 > \frac{Mass of the raw materials}{Mass of the raw materials + Mass of the compressive fluid} \geq 0.5$$

### —Raw Materials—

Substances, such as a ring-opening polymerizable monomer, used as raw materials in the aforementioned production method will be explained.

In the present embodiment, the raw materials are materials for producing a polymer and are materials that become constitutional components of a polymer. Moreover, the raw materials contain at least a ring-opening polymerizable monomer, and may further contain appropriately selected optional substances, such as an initiator, and additives.

### —Ring-Opening Polymerizable Monomer—

The ring-opening polymerizable monomer for use in the present embodiment is appropriately selected depending on the intended purpose without any limitation, and although it may depend on a combination of the ring-opening polymerizable monomer and a compressive fluid, the ring-opening polymerizable monomer is preferably a monomer having a ring structure containing a carbonyl bond, such as an ester bond. The carbonyl bond is formed with oxygen, which has high electronegativity, and carbon bonded together with a π-bond. Because of electrons of the π-bond, oxygen is negatively polarized, and carbon is positively polarized, and therefore enhances reactivity. In the case where the compressive fluid is carbon dioxide, it is assumed that affinity between carbon dioxide and a generated polymer is high, as the carbonyl bond is similar to the structure of carbon dioxide. As a result of these functions, a plasticizing effect of the generated polymer using the compressive fluid is enhanced. Examples of such ring-opening polymerizable monomer include cyclic ester, and cyclic carbonate. A polymer product producing using the aforementioned ring-opening polymerizable monomer is, for example, polyester or polycarbonate containing a carbonyl bond, such as an ester bond and a carbonate bond.

The cyclic ester is not particularly limited, but it is preferably a cyclic dimer obtained through dehydration-condensation of an L-form and/or D form of a compound represented by General Formula 1.

R—C*—H(—OH)(—COOH) General Formula 1

In General Formula 1, R is a C1-C10 alkyl group, and “C*” represents an asymmetric carbon.

Specific examples of the compound represented by General Formula 1 include enantiomers of lactic acid, enantiomers of 2-hydroxybutanoic acid, enantiomers of 2-hydroxypentanoic acid, enantiomers of 2-hydroxyhexanoic acid, enantiomers of 2-hydroxyheptanoic acid, enantiomers of 2-hydroxyoctanoic acid, enantiomers of 2-hydroxynonanoic acid, enantiomers of 2-hydroxydecanoic acid, enantiomers of 2-hydroxyundecanoic acid, and enantiomers of 2-hydroxydodecanoic acid. Among them, enantiomers of lactic acid are preferable since they are highly reactive and readily available. These cyclic dimers may be used independently or in combination.

Examples of the cyclic ester other than the compound represented by General Formula 1 include aliphatic lactone, such as β-propiolactone, β-butyrolactone, γ-butyrolactone, γ-hexanolactone, γ-octanolactone, δ-valerolactone, δ-hexanolactone, δ-octanolactone, ε-caprolactone, δ-dodecanolactone, α-methyl-γ-butyrolactone, β-methyl-δ-valerolactone, glycolide and lactide. Among them, ε-caprolactone is particularly preferable since it is highly reactive and readily available.

The cyclic carbonate is not particularly limited, and examples thereof include ethylene carbonate, and propylene carbonate. These ring-opening polymerizable monomers may be used independently, or in combination.

### —Catalyst—

In the present embodiment, a catalyst is suitably used.

The catalyst is appropriately selected depending on the intended purpose without any limitation, and it may be a metal catalyst containing a metal atom or an organic catalyst free from a metal atom.

The metal catalyst is appropriately selected from conventional metal catalysts depending on the intended purpose without any limitation, and examples thereof include: a tin compound, such as tin octylate, tin dibutylate, and tin di(2-ethylhexanoate); an aluminum compound, such as aluminum acetylacetonate, and aluminum acetate; a titanium compound, such as tetraisopropyl titanate, and tetrabutyl titanate; a zirconium compound, such as zirconium isopropoxide; and an antimony compound, such as antimony trioxide.

The catalyst used in the present embodiment is preferably an organic catalyst free from a metal atom (organic compound free from a metal atom) for applications which require safety and stability of a generated product. In the present embodiment, the organic catalyst free from a metal atom may be any organic catalyst, provided that it contributes to a ring-opening reaction of the ring-opening polymerizable monomer to form an active intermediate together with the ring-opening polymerizable monomer, and it then can be removed and regenerated through a reaction with alcohol.

The organic catalyst free from a metal atom is appropriately selected depending on the intended purpose without any limitation, but it is preferably a (nucleophilic) compound having basicity and serving as a nucleophilic agent, more preferably a basic nucleophilic nitrogen-containing compound (nitrogen compound), and even more preferably a basic nucleophilic nitrogen-containing cyclic compound. Note that, the nucleophilic agent (nucleophilicity) is chemical species (and characteristics thereof) that react with an electrophile. The aforementioned compound is not particularly limited, and examples thereof include cyclic monoamine, cyclic diamine (a cyclic diamine compound having an amidine skeleton), a cyclic triamine compound having a guanidine skeleton, a heterocyclic aromatic compound containing a nitrogen atom, N-heterocyclic carbine. Note that, a cationic organic catalyst is used for the ring-opening polymerization reaction, but the cationic organic catalyst takes hydrogen off (back-biting) from a principle chain of a polymer and therefore a molecular weight distribution of a resulting polymer product becomes wide and it is difficult to obtain the polymer product having high molecular weight.

Examples of the cyclic monoamine include quinaclidone. Examples of the cyclic diamine include 1,4-diazabicyclo[2.2.2]octane (DABCO) and 1,5-diazabicyclo(4,3,0)-5-nonene. Examples of the cyclic diamine compound having a diamine skeleton include 1,8-diazabicyclo[5.4.0]undec-7-ene (DBU) and diazabicyclononene. Examples of the cyclic triamine compound having a guanidine skeleton include 1,5,7-triazabicyclo[4.4.0]dec-5-ene (TBD) and diphenylguanidine (DPG).

Examples of the heterocyclic aromatic compound containing a nitrogen atom include N,N-dimethyl-4-aminopyridine (DMAP), 4-pyrrolidinopyridine (PPY), pyrrocolin, imidazole, pyrimidine and purine. Examples of the N-heterocyclic carbine include 1,3-di-tert-butylimidazol-2-ylidene (ITBU). Among them, DABCO, DBU, DPG, TBD, DMAP, PPY, and ITBU are preferable, as they have high nucleophilicity without being greatly affected by steric hindrance, or they have such boiling points that they can removed under the reduced pressure.

Among these organic catalysts free from metal atoms, for example, DBU is liquid at room temperature, and has a boiling point. In the case where such organic catalyst free from a metal atom is selected for use, the organic catalyst can be removed substantially quantitatively from the obtained polymer by treating the polymer under the reduced pressure. Note that, the type of the organic solvent, or whether or not a removal treatment is performed, is determined depending on an intended use of a generated polymer product.

An amount and type of the organic catalyst for use cannot be determined unconditionally as they vary depending on a combination of the compressive fluid and the ring-opening polymerizable monomer for use, but the amount thereof is preferably 0.01 mol % to 15 mol %, more preferably 0.1 mol % to 1 mol %, and even more preferably 0.3 mol % to 0.5 mol %, relative to 100 mol % of the ring-opening polymerizable monomer. When the amount thereof is smaller than 0.01 mol %, the organic catalyst is deactivated before completion of the polymerization reaction, and as a result a polymer having a target molecular weight cannot be obtained in some cases. When the amount thereof is greater than 15 mol %, it may be difficult to control the polymerization reaction.

### —Optional Substances—

In the production method of the present embodiment, other than the aforementioned ring-opening polymerizable monomer, a ring-opening polymerization initiator (initiator) and other additives can be used as optional substances of the raw materials.

### —Initiator—

In the present embodiment, an initiator is suitable used for controlling a molecular weight of a polymer as obtained. As for the initiator, a conventional initiator can be used. The initiator may be, for example, aliphatic mono or di alcohol, or polyhydric alcohol, as long as it is alcohol-based, and may be either saturated or unsaturated. Specific examples of the initiator include: monoalcohol such as methanol, ethanol, propanol, butanol, pentanol, hexanol, heptanol, nonanol, decanol, lauryl alcohol, myristyl alcohol, cetyl alcohol, and stearyl alcohol; dialcohol such as ethylene glycol, 1,2-propanediol, 1,3-propanediol, 1,3-butanediol, 1,4-butanediol, hexanediol, nonanediol, tetramethylene glycol, and polyethylene glycol; polyhydric alcohol such as glycerol, sorbitol, xylitol, ribitol, erythritol, and triethanol amine; and others such as methyl lactate, and ethyl lactate.

Moreover, a polymer having an alcohol residue at a terminal thereof, such as polycaprolactonediol and polytetramethylene glycol, may be used as the initiator. A use of such polymer enables to synthesize diblock copolymers or triblock compolymers.

An amount of the initiator may be appropriately adjusted depending on the intended molecular weight of a resulting polymer, but it is preferably 0.05 mol % to 5 mol %, relative to 100 mol % of the ring-opening polymerizable monomer. In order to prevent a reaction from being initiated unevenly, the initiator is preferably sufficiently mixed with the monomer before the monomer is brought into contact with a polymerization catalyst.

### —Additive—

Moreover, an additive may be added for the ring-opening polymerization, if necessary. Examples of the additive include a surfactant, an antioxidant, a stabilizer, an anticlouding agent, a UV ray-absorber, a pigment, a colorant, inorganic particles, various fillers, a thermal stabilizer, a flame retardant, a crystal nucleating agent, an antistatic agent, a surface wet improving agent, an incineration adjuvant, a lubricant, a natural product, a releasing agent, a plasticizer, and other similar components. If necessary, a polymerization terminator (e.g., benzoic acid, hydrochloric acid, phosphoric acid, metaphosphoric acid, acetic acid and lactic acid) may be used after completion of polymerization reaction. An amount of the additives varies depending on intended purpose for adding the additive, or a type of the additives, but it is preferably 0 parts by mass to 5 parts by mass, relative to 100 parts by mass of the polymer composition.

The surfactant for use is preferably a surfactant which is dissolved in the compressive fluid, and has compatibility to both the compressive fluid and the ring-opening polymerizable monomer. Use of such surfactant can give effects that the polymerization reaction can be uniformly preceded, and the resultant polymer has a narrow molecular weight distribution and be easily produced as particles. When the surfactant is used, the surfactant may be added to the compressive fluid, or may be added to the ring-opening polymerizable monomer. In the case where carbon dioxide is used as the compressive fluid, for example, a surfactant having groups having affinity with carbon dioxide and groups having affinity with the monomer can be used. Examples of such surfactant include a fluorosurfactant, and a silicone surfactant.

As for the stabilizer, used are epoxidized soybean oil, and carbodiimide. As for the antioxidant, 2,6-di-t-butyl-4-methyl phenol, and butylhydroxyanisol are used. As for the anticlouding agent, glycerin fatty acid ester, and monostearyl citrate are used. As for the filler, a thermal stabilizer, a flame retardant, an internal mold release agent, and inorganic additives having an effect of a crystal nucleus agent (e.g., clay, talc, and silica) are used. As for the pigment, titanium oxide, carbon black, and ultramarine blue are used.

### —Compressive Fluid—

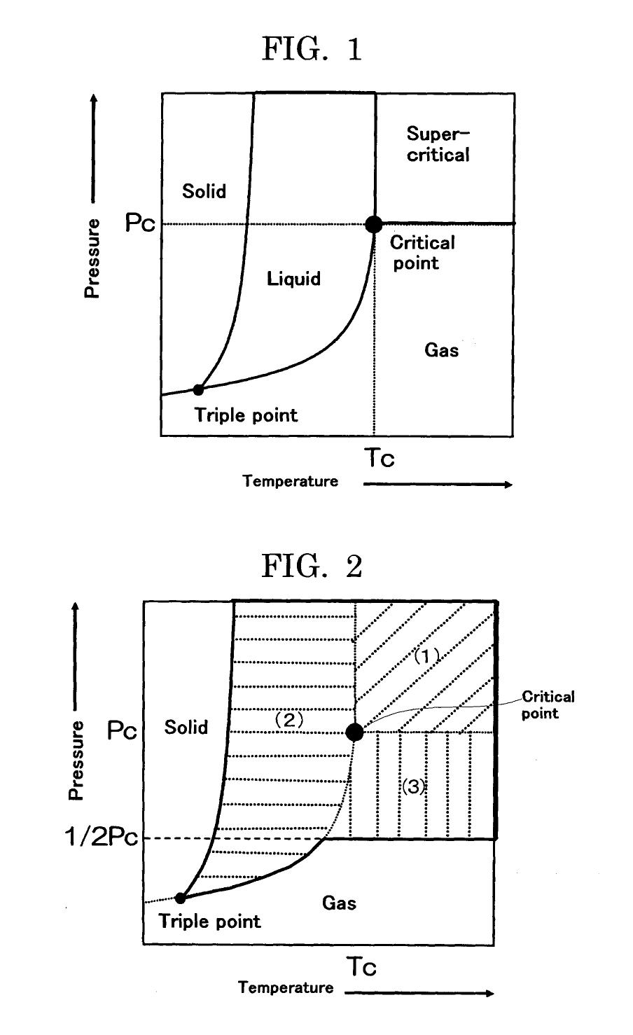

Next, a compressive fluid for use in the method for producing a polymer of the present embodiment is explained with reference to FIGS. 1 and 2. FIG. 1 is a phase diagram depicting the state of a substance depending on pressure and temperature conditions. FIG. 2 is a phase diagram which defines a compressive fluid used in the present embodiment. In the present embodiment, the term “compressive fluid” refers to a state of a substance present in any one of the regions (1), (2) and (3) of FIG. 2 in the phase diagram of FIG. 1.

In such regions, the substance is known to have extremely high density and show different behaviors from those shown at normal temperature and normal pressure. Note that, a substance is a supercritical fluid when it is present in the region (1). The supercritical fluid is a fluid that exists as a noncondensable high-density fluid at temperature and pressure exceeding the corresponding critical points, which are limiting points at which a gas and a liquid can coexist. When a substance is in the region (2), the substance is a liquid, but in the present embodiment, it is a liquefied gas obtained by compressing a substance existing as a gas at normal temperature (25° C.) and ambient pressure (1 atm). When a substance is in the region (3), the substance is in the state of a gas, but in the present invention, it is a high-pressure gas whose pressure is ½ or higher than the critical pressure (Pc), i.e. ½Pc or higher.

Examples of a substance that can be used in the state of the compressive fluid include carbon monoxide, carbon dioxide, dinitrogen oxide, nitrogen, methane, ethane, propane, 2,3-dimethylbutane, and ethylene. Among them, carbon dioxide is preferable because the critical pressure and critical temperature of carbon dioxide are respectively about 7.4 MPa, and about 31° C., and thus a supercritical state of carbon dioxide is easily formed. In addition, carbon dioxide is non-flammable, and therefore it is easily handled. These compressive fluids may be used independently, or in combination.

### <<Polymerization Reaction Device>>

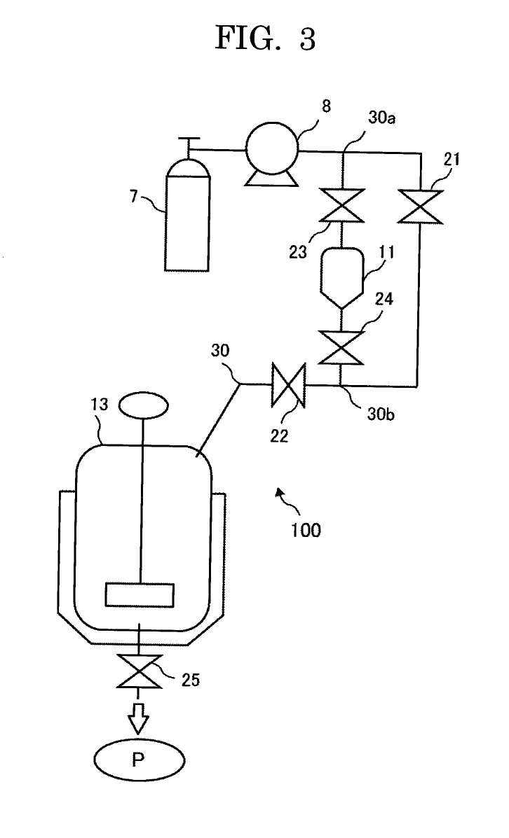

A polymerization reaction device suitably used in the method for producing a polymer of the present embodiment will be explained with reference to FIG. 3 next. FIG. 3 is a system diagram illustrating one example of the polymerization step in the present embodiment. The polymerization step in this embodiment may be a batch-type step, or a continuous-type step, but an example of the batch-type will be explained hereinafter.

In the system diagram of FIG. 3, a polymerization reaction device 100 contains a tank 7, a metering pump 8, an addition pot 11, a reaction vessel 13, and valves (21, 22, 23, 24, 25). The aforementioned devices are each connected in the manner as illustrated in FIG. 3 with a pressure resistant pipe 30. Moreover, the pipe 30 is provided with connectors (30a, 30b).

The tank 7 stores the compressive fluid. Note that, the tank 7 may contain gas or solid that is transformed into a compressive fluid upon application of heat or pressure in a supply path through which it is supplied to the reaction vessel 13, or in the reaction vessel 13. In this case, the gas or solid stored in the tank 7 is transformed into the state of (1), (2), or (3) in the phase diagram of FIG. 2 in the reaction vessel 13 by applying heat or pressure.

The metering pump 8 supplies the compressive fluid stored in the tank 7 to the reaction vessel 13 at constant pressure and flow rate. The addition pot 11 stores the catalyst to be added to the raw materials in the reaction vessel 13. By opening and closing each of the valves (21, 22, 23, 24), the path is switched between a path for supplying the compressive fluid stored in the tank 7 to the reaction vessel 13 via the addition pot 11, and a path for supplying the compressive fluid to the reaction vessel 13 without passing through the addition pot 11.

The reaction vessel 13 has been charged with the ring-opening polymerizable monomer and the initiator in advance. The reaction vessel 13 is a pressure resistant vessel configured to bring the previously charged ring-opening polymerizable monomer and initiator into contact with the compressive fluid supplied from the tank 7 and the catalyst supplied from the addition pot 11, to thereby carry out ring-opening polymerization of the ring-opening polymerizable monomer. Note that, the reaction vessel 13 may be provided with a gas outlet for releasing evaporated materials. Moreover, the reaction vessel 13 contains a heater for heating the raw materials and the compressive fluid. Further, the reaction vessel 13 contains a stirring device for stirring the raw materials and the compressive fluid. The stirring device prevents sedimentation of generated polymer by stirring when there is a difference in concentration between the raw materials and the polymer product. Therefore, the polymerization reaction can be carried out more uniformly and quantitatively. The valve 25 discharges the compressive fluid and the polymer product (polymer) in the reaction vessel 13 by opening after the completion of the polymerization reaction.

### <<Polymerization Method>>

Next, a polymerization method of a ring-opening polymerizable monomer using the polymerization reaction device 100 will be explained. In the present embodiment, the raw materials containing the ring-opening polymerizable monomer and the compressive fluid are brought into contact with each other at a predetermined mixing ratio to thereby carry out ring-opening polymerization of the ring-opening polymerizable monomer. In this case, first, the metering pump 8 is operated and the valves (21, 22) are open to thereby supply the compressive fluid stored in the tank 7 to the reaction vessel 13 without going through the addition pot 11. As a result, the previously charged ring-opening polymerizable monomer and initiator are brought into contact with the compressive fluid supplied from the tank 7 in the reaction vessel 13, and the mixture is stirred by the stirring device so that the raw materials, such as the ring-opening polymerizable monomer, are melted. In the present embodiment, “melted” means that the raw materials or the generated polymer is plasticized or liquidized with swelling as a result of the contact with the compressive fluid.

In the polymerization step, preferably, the bringing the compressive fluid and the raw materials containing the ring-opening polymerizable monomer into contact with each other makes the ring-opening polymerizable monomer melt. When ring-opening polymerization is performed with melting the ring-opening polymerizable monomer, the reaction progresses with the high ratio of the raw materials, and therefore the efficiency of the reaction improves.

In this case, a ratio (mixing ratio) of the raw materials to the compressive fluid in the reaction vessel 13 is within the ratio represented by the following formula (i).

$$1 > \frac{Mass of the raw materials}{\begin{matrix}Mass of the raw materials + \\ Mass of the compressive fluid\end{matrix}} \geq 0.5 \qquad Formula ( i )$$

In the present embodiment, the raw materials in the formula above contain the ring-opening polymerizable monomer and the initiator. The mixing ratio is appropriately selected depending on the intended purpose without any limitation, provided that it is 0.5 or more but less than 1. The mixing ratio is preferably 0.65 to 0.99, more preferably 0.80 to 0.95. When the mixing ratio is less than 0.5, an amount of the compressive fluid for use increases and thus not economical, and moreover as the density of the ring-opening polymerizable monomer becomes low, polymerization speed may be slow down. When the mixing ratio is less than 0.5, moreover, the mass of the compressive fluid is greater than the mass of the raw materials, and therefore a melted phase of the melted ring-opening polymerizable monomer and a fluid phase in which the ring-opening polymerizable monomer is melted with the compressive fluid are co-existed, which may make uniform proceeding of the reaction difficult. Note that, the aforementioned range of the mixing ratio can be applied in both the step of the batch system and the step of the continuous system. In case of the step of the continuous system, the range of the mixing ratio is represented by the following formula (ii).

$$1 > \frac{\begin{matrix}Feeding speed of \\ the raw material ( g \text{/} min )\end{matrix}}{\begin{matrix}Feeding speed of the raw materials ( g \text{/} min ) + \\ Feeding speed of the compressive fluid ( g \text{/} min )\end{matrix}} \geq 0.5 \qquad Formula ( ii )$$

The temperature and pressure at which the ring-opening polymerizable monomer is melted in the reaction vessel 13 is controlled to the temperature and pressure at least equal to or higher than the triplet point of the compressive fluid to thereby prevent the fed compressive fluid from transforming into gas. This is controlled by adjusting output of a heater of the reaction vessel 13 or a degree of opening or closure of the valves (21, 22). In the present embodiment, the temperature at which the ring-opening polymerizable monomer is melted may be temperature equal to or lower than the melting point of the ring-opening polymerizable monomer under atmospheric pressure. The internal pressure of the reaction vessel 13 becomes high in the presence of the compressive fluid, and thus the melting point of the ring-opening polymerizable monomer becomes low. As a result, the ring-opening polymerizable monomer melts in the reaction vessel 13 even the state where the amount of the compressive fluid is small and the value of the mixing ratio is large.

Moreover, the timing for applying heat to or starting stirring each of the raw materials and the compressive fluid in the reaction vessel 13 may be adjusted so as to sufficiently melt each of the raw materials. In this case, heat or stirring may be applied or started after or during each of the raw materials is brought into contact with the compressive fluid. Moreover, the ring-opening polymerizable monomer and the compressive fluid may be brought into contact with each other after heat having temperature equal to or higher than the melting point of the ring-opening polymerizable monomer is applied to the ring-opening polymerizable monomer to melt in advance.

Subsequently, the valves (23, 24) are open to thereby supply the catalyst stored in the addition pot 11 to the reaction vessel 13. The catalyst supplied to the reaction vessel 13 is optionally sufficiently stirred by the stirring device of the reaction vessel 13, and is heated to the predetermined temperature by the heater. As a result, the ring-opening polymerizable monomer is proceeded to ring-opening polymerization in the presence of the catalyst in the reaction vessel 13, to thereby generate a polymer.

As for a range of temperature during ring-opening polymerization of the ring-opening polymerizable monomer (polymerization reaction temperature), the lower limit is preferably temperature lower than a melting point of the ring-opening polymerizable monomer by 50° C., and the upper limit is preferably temperature higher than the melting point of the ring-opening polymerizable monomer by 50° C. When the polymerization reaction temperature is lower than the temperature lower than the melting point of the ring-opening polymerizable monomer by 50° C., the reaction speed may be low during the polymerization, by which the polymerization reaction may not be able to progress quantitatively. When the polymerization reaction temperature is higher than the temperature higher than the melting point of the ring-opening polymerizable monomer by 50° C., a depolymerization reaction, which is a reverse reaction of ring-opening polymerization, tends to occur equibliumly, by which the polymerization reaction may not be progressed quantitatively. Moreover, the upper limit of the polymerization reaction temperature is more preferably 100° C. or lower. Note that, the ring-opening polymerizable monomer may be subjected to ring-opening polymerization at temperature outside the aforementioned range, depending on a combination of the compressive fluid, ring-opening polymerizable monomer, and catalyst.

In a conventional production method of a polymer using supercritical carbon dioxide, polymerization of a ring-opening polymerizable monomer is carried out using a large amount of supercritical carbon dioxide as supercritical carbon dioxide has low ability of dissolving a polymer. In accordance with the polymerization method of the present embodiment, ring-opening polymerization of a ring-opening polymerizable monomer is performed with a high concentration, which has not been realized in a conventional art, in the course of producing a polymer using a compressive fluid. In this case, the pressure applied to the reaction system inside the reaction vessel 13 becomes high in the presence of the compressive fluid, and thus glass transition temperature (Tg) of a polymer product becomes low. As a result, the produced polymer product has low viscosity, and therefore a ring-opening reaction uniformly progresses even in the state where the concentration of the polymer product is high.

In the present embodiment, the polymerization reaction time is appropriately set depending on a target molecular weight of a polymer to be formed. In the case where the target molecular weight is 3,000 to 100,000, the polymerization reaction time is 2 hours to 24 hours.

The pressure for the polymerization, i.e., the pressure of the compressive fluid, may be the pressure at which the compressive fluid supplied by the tank 7 becomes a liquid gas ((2) in the phase diagram of FIG. 2), or high pressure gas ((3) in the phase diagram of FIG. 2), but it is preferably the pressure at which the compressive fluid becomes a supercritical fluid ((1) in the phase diagram of FIG. 2). By making the compressive fluid into the state of a supercritical fluid, melting of the ring-opening polymerizable monomer is accelerated to uniformly and quantitatively progress a polymerization reaction. In the case where carbon dioxide is used as the compressive fluid, the pressure is 3.7 MPa or higher, preferably 5 MPa or higher, more preferably 7.4 MPa or higher, which is the critical pressure or higher, in view of efficiency of a reaction and polymerization rate. In the case where carbon dioxide is used as the compressive fluid, moreover, the temperature thereof is preferably 25° C. or higher from the same reasons to the above.

The moisture content in the reaction section 13 is preferably 4 mol % or less, more preferably 1 mol % or less, and even more preferably 0.5 mol % or less, relative to 100 mol % of the ring-opening polymerizable monomer. When the moisture content is greater than 4 mol %, it may be difficult to control a molecular weight of a resulting product as the moisture itself acts as an initiator. In order to control the moisture content in the polymerization system, an operation for removing moistures contained in the ring-opening polymerizable monomer and other raw materials may be optionally provided as a pretreatment.

To the polymer obtained through polymerization of the ring-opening polymerizable monomer, a urethane bond or ether bond can be introduced. Similarly to the ring-opening polymerizable monomer, the urethane bond or ether bond can be introduced by carrying out a polyaddition reaction in a compressive fluid with addition of an isocyanate compound or glycidyl compound. In this case, a preferable method thereof for controlling a resulting molecular structure is a method in which the aforementioned compound is separately added after completion of a polymerization reaction of the ring-opening polymerizable monomer.

The isocyanate compound used in the polyaddition reaction is not particularly limited, and examples thereof include a polyfunctional isocyanate compound, such as isophorone diisocyanate, hexamethylene diisocyanate, lysine diisocyanate, xylene diisocyanate, tolylene diisocyanate, diphenylmethane diisocyanate, and cyclohexane diisocyanate. The glycidyl compound is not particularly limited, and examples thereof include a polyfunctional glycidyl compound, such as diethylene glycol diglycidyl ether, polyethylene glycol diglycidyl ether, neopentyl glycol diglycidyl ether, 1,6-hexanediol diglycidyl ether, and diglycidyl terephthalate.

The polymer product P completed the ring-opening polymerization reaction in the reaction vessel 13 is discharged from the valve 25 to sent outside of the reaction vessel 13.

In the production method of the present embodiment, the polymerization rate of the ring-opening polymerizable monomer through ring-opening polymerization is 96 mol % or higher, preferably 98 mol % or higher. When the polymerization rate is less than 96 mol %, the polymer product does not have satisfactory thermal characteristics to function as a polymer product, and moreover it may be necessary to separately provide an operation for removing a ring-opening polymerizable monomer. Note that, in the present embodiment, the polymerization rate is a ratio of the ring opening polymerizable monomer contributed to generation of a polymer, relative to the ring-opening polymerizable monomer of the raw materials. The amount of the ring-opening polymerizable monomer contributed to generation of a polymer can be obtained by deducting the amount of the unreacted ring-opening polymerizable monomer (ring-opening polymerizable monomer residues) from the amount of the generated polymer.

The amount of the ring-opening polymerizable monomer residues contained in a polymer product obtained by the production method of the present embodiment is preferably 2 mol % or lower, more preferably 0.5 mol % or lower, and even more preferably 0.1 mol % or lower. When the amount of the ring-opening polymerizable monomer residue is greater than 2 mol %, heat resistant stability of a resulting polymer product becomes poor due to impaired thermal characteristics thereof, and moreover the decomposition of the polymer tends to progress as carboxylic acid generated by ring-opening of the monomer residue functions as a catalyst for accelerating hydrolysis decomposition.

The number average molecular weight of the polymer product obtained in the present embodiment can be adjusted by adjusting an amount of the initiator. The number average molecular weight thereof is not particularly limited and can be adjusted depending on the intended use, but it is generally 12,000 to 200,000. Note that, in the present embodiment, the number average molecular weight is calculated based on a measurement of gel permeation chromatography (GPC). When the number average molecular weight thereof is greater than 200,000, productivity is low because of the increased viscosity, which is not economically advantageous. When the number average molecular weight thereof is smaller than 12,000, it may not be preferable because a polymer product may have insufficient strength to function as a polymer. The value (Mw/Mn) obtained by dividing the weight average molecular weight Mw of the polymer product obtained by the present embodiment with the number average molecular weight Mn thereof is preferably in the range of 1.0 to 2.5, more preferably 1.0 to 2.0. When the value thereof is greater than 2.0, it is not preferable as the polymerization reaction may have progressed non-uniformly to produce a polymer product, and therefore it is difficult to control physical properties of the polymer.

The polymer product obtained by the production method of the present embodiment is substantially free from an organic solvent, as it is produced by the method without using the organic solvent, and has an extremely small amount of the ring-opening polymerizable monomer residues, which is 2 mol % or less. Therefore, the polymer product obtained by the production method of the present embodiment is excellent in safety and stability. In the present embodiment, the organic solvent means a solvent of an organic matter used for a ring-opening polymerization, and dissolves a polymer product obtained through a ring-opening polymerization reaction. In the case where a polymer obtained through a ring-opening polymerization reaction is polylactic acid (L-form 100%), examples of the organic solvent include: a halogen-containing solvent, such as chloroform, and methylene chloride; and tetrahydrofuran. The fact “substantially free from an organic solvent” means that the amount of the organic solvent in the polymer product is the detection limit or smaller as measured by the following method.

### (Measurement Method of Organic Solvent Residues)

To 1 part by mass of the polymer product, which is a subject of the measurement, 2 parts by mass of 2-propanol was added, and the resultant was dispersed for 30 minutes by ultrasonic waves. Then, the resultant is stored in a refrigerator (5° C.) for 1 day or longer, to thereby extract an organic solvent in the polymer product. The supernatant fluid thus obtained was analyzed by gas chromatography (GC-14A, SHIMADZU), to determine the organic solvent and the monomer residues in the polymer product, and to thereby measure a concentration of the organic solvent. The measuring conditions of this analysis are as follows.

### Device: GC-14A Shimadzu

### Column: CBP20-M 50-0.25

Detector: FID Injection amount: 1 μL to 5 μL
Carrier gas: He, 2.5 kg/cm²
Flow rate of hydrogen: 0.6 kg/cm²
Flow rate of air: 0.5 kg/cm²
Chart speed: 5 mm/min

### Sensitivity: Range 101×Atten 20

Column temperature: 40° C.
Injection temperature: 150° C.

Moreover, in the case where a polymer is produced by the production method of the present embodiment without using a metal catalyst, a resulting polymer product is substantially free from a metal atom. The phrase “substantially free from a metal atom” refers to not containing a metal atom derived from the metal catalyst. Specifically, a polymer product can be said it is substantially free from a metal atom, when the metal atom derived from the metal catalyst in the polymer product is detected by conventional analysis methods, such as ICP-atomic emission spectrometry, atomic absorption spectrophotometry, and colorimetry, and the result is equal to or lower than the detection limit. Examples of the metal atom derived from the metal catalyst include tin, aluminum, titanium, zirconium, and antimony.

### <<Use of Polymer Product>>

The polymer product obtained by the method for producing a polymer of the present embodiment is produced by the method without using an organic solvent, and an amount of monomer residues contained therein is small, and therefore the polymer product is excellent in safety and stability. Accordingly, the polymer product obtained by the method for producing a polymer of the present embodiment can be widely used in various uses, such as an electrophotographic developer, an ink for printing, a coating for buildings, a cosmetic product, and a medical material.

### <<Effects of Present Embodiment>>

In a conventional melt polymerization method of a ring-opening polymerizable monomer, a reaction is generally performed at high temperature, i.e., 150° C. or higher, and therefore unreacted monomer residues remain in a resulting polymer product. Therefore, in some cases, it is necessary to provide a step for removing the unreacted monomers. Moreover, a solution polymerization is performed using a solvent, it is necessary to provide a step for removing the solvent in order to use a resulting polymer as a solid. Accordingly, any of these conventional methods cannot avoid increased cost due to increase in the number of steps in the production, or decrease in yield.

In accordance with the method for producing a polymer of the present embodiment, it is possible to provide a polymer having excellent mold formability and thermal stability at low cost, with low environmental load, energy saving, and resource saving, by controlling a supplying amount of the compressive fluid, etc.

(1) A reaction proceeds at low temperature compared to a melt polymerization method in which a reaction is preceded by heating at temperature higher than the melting point of the ring-opening polymerizable monomer.
(2) As the reaction proceeds at low temperature, a side reaction hardly occurs, and thus a polymer can be obtained at high yield relative to an amount of the ring-opening polymerizable monomer added (namely, an amount of unreacted ring-opening polymerizable monomer is small). Accordingly, a purification step for removing unreacted ring-opening polymerizable monomer, which is performed for attaining a polymer having excellent mold formability and thermal stability, can be simplified, or omitted.
(3) As a metal-free organic compound can be selected as a catalyst for use in the production of a polymer, intended use of which does not favor inclusion of a certain metal, it is not necessary to provide a step for removing the catalyst.
(4) In a polymerization method using an organic solvent, it is necessary to provide a step for removing a solvent to thereby yield a polymer product as a solid. In addition, it is still difficult to completely remove the organic solvent even by the step for removing the solvent. In the polymerization method of the present embodiment, a drying step is simplified or omitted, because a waste liquid is not generated, and a dry polymer product can be obtained with one stage, as a compressive fluid is used.
(5) It is possible to attain both desirable polymerization speed and polymerization efficiency (a ratio of a polymer product relative to the polymerization system) by controlling a supplying amount of the compressive fluid.
(6) A uniform proceeding of a reaction can be achieved, because ring-opening polymerization is carried out by adding a catalyst after melting the ring-opening polymerizable monomer with the compressive fluid.

### EXAMPLES

The present invention will be more specifically explained with reference to Examples and Comparative Examples, but Examples shall not be construed to as limit the scope of the present invention in any way. Note that, a molecular weight of a polymer product and polymerization rate of a monomer in Examples and Comparative Examples were measured in the following manner.

### <Measurement of Molecular Weight of Polymer Product>

The molecular weight of the polymer product was measured by gel permeation chromatography (GPC) under the following conditions.

Apparatus: GPC-8020 (product of TOSOH CORPORATION)
Column: TSK G2000HXL and G4000HXL (product of TOSOH CORPORATION)

### Temperature: 40° C.

### Solvent: Tetrahydrofuran (THF)

Flow rate: 1.0 mL/min

First, a calibration curve of molecular weight was obtained using monodispersed polystyrene serving as a standard sample. A polymer sample (1 mL) having a polymer concentration of 0.5% by mass was applied and measured under the above conditions, to thereby obtain the molecular weight distribution of the polymer. The number average molecular weight Mn and the weight average molecular weight Mw of the polymer were calculated from the calibration curve. The molecular weight distribution is a value calculated by dividing Mw with Mn.

### <Polymerization Rate of Monomer (mol %)>

Nuclear magnetic resonance (NMR) spectroscopy of the polymer product was performed in deuterated chloroform by means of a nuclear magnetic resonance apparatus (JNM-AL300, of JEOL Ltd.). In the case where the polymer was polylactic acid, a ratio of a quartet peak area attributed to lactide (4.98 ppm to 5.05 ppm) to a quartet peak area attributed to polylactic acid (5.10 ppm to 5.20 ppm) was calculated, and an amount of the unreacted lactide monomer (mol %) was determined by multiplying the obtained value from the calculation with 100. The polymerization rate is the value obtained by deducting the calculated amount of the unreacted monomer from 100.

### Example 1

Ring-opening polymerization of a mixture (mass ratio: 90/10, manufacturer: Purac, melting point: 100° C.) of L-lactide and D-lactide was performed by means of the polymerization reaction device 100 of FIG. 3. The configuration of the polymerization reaction device 100 was as follows.

Tank 7: Carbonic acid gas cylinder

### Addition pot 11:

A ¼-inch SUS316 pipe was sandwiched with valves (23, 24), and the resultant was used as an addition pot. The addition pot was charged with 0.5 g of 1,8-diazabicyclo[5.4.0]undec-7-ene (DBU) (manufacturer: Tokyo Chemical Industry Co., Ltd.) in advance.

Reaction vessel 13:

A 100 mL SUS316 pressure resistant vessel was used. This vessel was charged with 108 g of a mixture (molar ratio: 99/1) of (a) fluid lactide (a mixture (mass ratio: 90/10) of L-lactide and D-lactide, manufacturer: Purac, melting point: 100° C.) as the ring-opening polymerizable monomer, and (b) lauryl alcohol as the initiator, in advance.

The metering pump 8 was operated and the valves (21, 22) were open to thereby supply carbon dioxide stored in the tank 7 to the reaction vessel 13 without going through the addition pot 11. After replacing the atmosphere of the reaction vessel 13 with carbon dioxide, the reaction vessel 13 was charged with carbon dioxide until the internal pressure of the reaction vessel 13 reached 15 MPa, so that the lactide was allowed to melt. After cooling the internal temperature of the reaction vessel 13 to 60° C., the valves (23, 24) were open to supply 1,8-diazabicyclo[5.4.0]undec-7-ene (DBU) stored in the addition pot 11 to the reaction vessel 13. Thereafter, lactide was allowed to proceed to a polymerization reaction for 0.5 hours in the reaction vessel 13. After completing the reaction, the valve 25 was open, and the internal temperature and pressure of the reaction vessel 13 were gradually returned to room temperature and ambient pressure. Three hours later, a polymer product (polylactic acid) in the reaction vessel 13 was taken out. The physical properties (Mn, Mw/Mn, polymerization rate) of the polymer product were measured by the aforementioned methods. The results are depicted in Table 1. Note that, the mixing ratio in Table 1 was calculated by the following formula.

Spatial volume of supercritical carbon dioxide: 100 mL-108 g/1.27 (specific gravity of raw materials)=15 mL
Mass of supercritical carbon dioxide: 15 mL×0.605 (specific gravity of carbon dioxide at 60° C., 15 MPa)=9.1
Mixing ratio: 108 g/(108 g+9.1 g)=0.92

Note that, in Tables 1 to 4, the specific gravity of carbon dioxide is expressed as “density.”

### Examples 2 to 4

Polymer products of Examples 2 to 4 were produced in the same manner as in Example 1, provided the amount of the initiator for use was changed to those as depicted in the columns thereof for Examples 2 to 4 of Table 1. Physical properties of the obtained polymer products were measured by the aforementioned manners. The results are presented in Table 1.

### Examples 5 to 7

Polymer products of Examples 5 to 7 were produced in the same manner as in Example 1, provided that the mixing ratio and the reaction temperature were respectively changed to those as depicted in the columns thereof for Examples 5 to 7 of Table 1. Physical properties of the obtained polymer products were measured by the aforementioned manners. The results are presented in Table 1.

### Examples 8 to 10

Polymer products of Examples 8 to 10 were produced in the same manner as in Example 1, provided that the mixing ratio and the reaction pressure were respectively changed to those as depicted in the columns for Examples 8 to 10 of Table 2. Physical properties of the obtained polymer products were measured by the aforementioned manners. The results are presented in Table 2.

### Examples 11 to 13, and Comparative Examples 1 to 2

Polymer products of Examples 11 to 13 and Comparative Examples 1 to 2 were produced in the same manner as in Example 1, provided that an amount of the raw materials added to the reaction vessel 13 was changed to 90 g (Example 11), 70 g (Example 12), 50 g (Example 13), 30 g (Comparative Example 1), and 10 g (Comparative Example 2). Physical properties of the obtained polymer products were measured by the aforementioned manners. The results are presented in Tables 2 and 4.

### Examples 14 to 16

Polymer products of Examples 14 to 16 were produced in the same manner as in Example 1, provided that the catalyst for use was changed to 1,4-diazabicyclo-[2.2.2]octane (DABCO) (manufacturer: Tokyo Chemical Industry Co., Ltd.) (Example 14), 4-dimethylaminopyridine (DMAP) (manufacturer: Tokyo Chemical Industry Co., Ltd.) (Example 15), and 1,3-di-tert-butylimidazol-2-ylidene (ITBU) (manufacturer: Tokyo Chemical Industry Co., Ltd.) (Example 16), and the reaction pressure was changed as depicted in the columns thereof for Examples 14 to 16 of Table 3. Physical properties of the obtained polymer products were measured by the aforementioned manners. The results are presented in Table 3.

### Examples 17 to 18

Polymer products of Examples 17 to 18 were produced in the same manner as in Example 1, provided that the ring-opening polymerizable monomer was changed to ε-caplactone (melting point: −1° C.) in Example 17, and to ethylene carbonate (melting point: 34° C. to 37° C.) in Example 18, the catalyst for use was changed to 1,5,7-triazabicyclo[4.4.0]dec-5-ene (TBD) (manufacturer: Tokyo Chemical Industry Co., Ltd.) in Example 17, and the polymerization reaction was carried out for 2 hours in both Examples 17 and 18. Physical properties of the obtained polymer products were measured by the aforementioned manners. The results are presented in Table 3.

### Examples 19 to 21

Polymer products of Examples 19 to 21 were produced in the same manner as in Example 1, provided that the reaction was carried out at 150° C. using tin di(2-ethylhexanoate) as the catalyst, and the amount of the initiator was changed as depicted in Table 4. Physical properties of the obtained polymer products were measured by the aforementioned manners. The results are presented in Table 4. Note that, in Table 4, tin di(2-ethylhexanoate) is abbreviated as “tin.”

TABLE 1

| | Ex. 1 | Ex. 2 | Ex. 3 | Ex. 4 | Ex. 5 | Ex. 6 | Ex. 7 |
|---|---|---|---|---|---|---|---|
| Catalyst | DBU | DBU | DBU | DBU | DBU | DBU | DBU |
| Ring- | Lactide | Lactide | Lactide | Lactide | Lactide | Lactide | Lactide |
| opening | | | | | | | |
| polymerizable | | | | | | | |
| monomer | | | | | | | |
| Mixing | 0.92 | 0.92 | 0.92 | 0.92 | 0.90 | 0.91 | 0.94 |
| ratio | | | | | | | |
| Amount of | 1.00 | 3.00 | 0.50 | 0.25 | 1.00 | 1.00 | 1.00 |
| initiator | | | | | | | |
| (mol %) | | | | | | | |
| Pressure | 15 | 15 | 15 | 15 | 15 | 15 | 15 |
| (MPa) | | | | | | | |
| Temp. | 60 | 60 | 60 | 60 | 40 | 50 | 80 |
| (° C.) | | | | | | | |
| Density of | 0.60 | 0.60 | 0.60 | 0.60 | 0.78 | 0.70 | 0.43 |
| supercritical | | | | | | | |
| CO₂ | | | | | | | |
| (g/cm³) | | | | | | | |
| Reaction | 0.5 | 0.5 | 0.5 | 0.5 | 0.5 | 0.5 | 0.5 |
| time (hr) | | | | | | | |
| Mn | 11,000 | 5,100 | 23,000 | 57,000 | 12,000 | 10,000 | 10,000 |
| Mw/Mn | 1.9 | 1.8 | 2.0 | 2.1 | 1.7 | 1.8 | 1.9 |
| Polymerization | 99 | 100 | 99 | 99 | 97 | 98 | 99 |
| rate | | | | | | | |
| (mol %) | | | | | | | |

TABLE 2

| | Ex. 8 | Ex. 9 | Ex. 10 | Ex. 11 | Ex. 12 | Ex. 13 |
|---|---|---|---|---|---|---|
| Catalyst | DBU | DBU | DBU | DBU | DBU | DBU |
| Ring-opening | Lactide | Lactide | Lactide | Lactide | Lactide | Lactide |
| polymerizable | | | | | | |
| monomer | | | | | | |
| Mixing ratio | 0.96 | 0.91 | 0.90 | 0.83 | 0.72 | 0.57 |
| Amount of | 1.00 | 1.00 | 1.00 | 1.00 | 1.00 | 1.00 |
| initiator | | | | | | |
| (mol %) | | | | | | |
| Pressure (MPa) | 10 | 20 | 30 | 15 | 15 | 15 |
| Temp. | 60 | 60 | 60 | 60 | 60 | 60 |
| (° C.) | | | | | | |
| Density of | 0.29 | 0.72 | 0.83 | 0.60 | 0.60 | 0.60 |
| supercritical | | | | | | |
| CO₂ (g/cm³) | | | | | | |
| Reaction time | 0.5 | 0.5 | 0.5 | 0.5 | 0.5 | 0.5 |
| (hr) | | | | | | |
| Mn | 9,600 | 9,700 | 11,000 | 11,000 | 11,000 | 11,000 |
| Mw/Mn | 1.9 | 1.9 | 2.0 | 2.1 | 1.9 | 1.8 |
| Polymerization | 99 | 100 | 99 | 99 | 97 | 97 |
| rate (mol %) | | | | | | |

TABLE 3

| | Ex. 14 | Ex. 15 | Ex. 16 | Ex. 17 | Ex. 18 |
|---|---|---|---|---|---|
| Catalyst | DABCO | DMAP | ITBU | TBD | DBU |
| Ring- | Lactide | Lactide | Lactide | ε-capro- | Ethylene |
| opening | | | | lactone | carbonate |
| poly- | | | | | |
| merizable | | | | | |
| monomer | | | | | |
| Mixing ratio | 0.92 | 0.92 | 0.92 | 0.92 | 0.92 |
| Amount of | 1.00 | 1.00 | 1.00 | 1.00 | 1.00 |
| initiator | | | | | |
| (mol %) | | | | | |
| Pressure | 10 | 20 | 30 | 15 | 15 |
| (MPa) | | | | | |
| Temp. (° C.) | 60 | 60 | 60 | 60 | 60 |
| Density of | 0.29 | 0.72 | 0.83 | 0.60 | 0.60 |
| supercritical | | | | | |
| CO₂ (g/cm³) | | | | | |
| Reaction | 0.5 | 0.5 | 0.5 | 2.0 | 2.0 |
| time (hr) | | | | | |
| Mn | 10,000 | 10,000 | 12,000 | 11,000 | 10,000 |
| Mw/Mn | 2.0 | 1.8 | 1.9 | 2.1 | 1.9 |
| Poly- | 92 | 96 | 99 | 96 | 95 |
| merization | | | | | |
| rate (mol %) | | | | | |

TABLE 4

| | | | | Comp. | Comp. |
|---|---|---|---|---|---|
| | Ex. 19 | Ex. 20 | Ex. 21 | Ex. 1 | Ex. 2 |
| Catalyst | tin | tin | tin | DBU | DBU |
| Ring- | Lactide | Lactide | Lactide | Lactide | Lactide |
| opening | | | | | |
| poly- | | | | | |
| merizable | | | | | |
| monomer | | | | | |
| Mixing ratio | 0.97 | 0.97 | 0.97 | 0.44 | 0.15 |
| Amount of | 1.00 | 0.25 | 0.10 | 1.00 | 1.00 |
| initiator | | | | | |
| (mol %) | | | | | |
| Pressure | 15 | 15 | 15 | 15 | 15 |
| (MPa) | | | | | |
| Temp. (° C.) | 150 | 150 | 150 | 60 | 60 |
| Density of | 0.23 | 0.23 | 0.23 | 0.60 | 0.60 |
| supercritical | | | | | |
| CO₂ (g/cm³) | | | | | |
| Reaction | 0.5 | 0.5 | 0.5 | 0.5 | 0.5 |
| time (hr) | | | | | |
| Mn | 11,000 | 55,000 | 13,000 | 10,000 | 11,000 |
| Mw/Mn | 2.0 | 1.8 | 2.1 | 2.2 | 2.1 |
| Poly- | 100 | 99 | 98 | 94 | 88 |
| merization | | | | | |
| rate (mol %) | | | | | |

Aspects of the present invention are as follows, for example:

<1> A method for producing a polymer, including:

(i) bringing a compressive fluid and raw materials containing a ring-opening polymerizable monomer into contact with each other at a mixing ratio represented by the following formula, to thereby allow the ring-opening polymerizable monomer to carry out ring-opening polymerization:

$$1 > \frac{Mass of the raw materials}{Mass of the raw materials + Mass of the compressive fluid} \geq 0.5$$

<2> The method for producing a polymer according to <1>,

wherein the compressive fluid has a density of 0.23 g/cm³ to 0.83 g/cm³.

<3> The method for producing a polymer according to <1> or <2>,

wherein the bringing the compressive fluid and the raw materials containing the ring-opening polymerizable monomer into contact with each other makes the ring-opening polymerizable monomer melt.

<4> The method for producing a polymer according any one of <1> to <3>,

wherein the ring-opening polymerizable monomer is allowed to carry out the ring-opening polymerization in the presence of an organic catalyst free from a metal atom.

<5> The method for producing a polymer according to any one of <1> to <4>,

wherein a polymerization rate of the ring-opening polymerizable monomer is 98 mol % or higher.

<6> The method for producing a polymer according to any one of <1> to <5>,

wherein the polymer has a number average molecular weight of 12,000 or greater.

<7> The method for producing a polymer according to any one of <1> to <6>,

wherein the compressive fluid contains carbon dioxide.

<8> The method for producing a polymer according to <4>,

wherein the organic catalyst free from a metal atom is a basic nucleophilic nitrogen compound.

<9> The method for producing a polymer according to any one of <1> to <8>,

wherein the ring-opening polymerizable monomer is a monomer having a ring structure containing an ester bond therein.

<10> The method for producing a polymer according to any one of <1> to <9>,

wherein a lower limit of a temperature during the ring-opening polymerization in the (i) is lower than a melting point of the ring-opening polymerizable monomer by 50° C., and an upper limit of the temperature during the ring-opening polymerization in the (i) is higher than the melting point of the ring-opening polymerizable monomer by 50° C.

<11> The method for producing a polymer according to any one of <1> to <9>,

wherein an upper limit of a temperature during the ring-opening polymerization in the (i) is 100° C.

### REFERENCE SIGNS LIST

7: tank
8: metering pump
11: addition pot
13: reaction vessel
21, 22, 23, 24, 25: valve
100: polymerization reaction device

1. A method for producing a polymer, comprising:
bringing a compressive fluid and raw materials comprising a ring-opening polymerizable monomer into contact with each other at a mixing ratio of
$$1 > \frac{mass of the raw materials}{mass of the raw materials + mass of the compressive fluid} \geq 0.5$$
thereby conducting ring-opening polymerization.

2. The method according to claim 1,
wherein the compressive fluid has a density of from 0.23 g/cm³ to 0.83 g/cm³.

3. The method according to claim 1,
wherein the bringing makes the ring-opening polymerizable monomer melt.

4. The method according to claim 1,
wherein the ring-opening polymerization is conducted in the presence of an organic catalyst free from a metal atom.

5. The method according to claim 1,
wherein a polymerization rate of the ring-opening polymerizable monomer is 98 mol % or higher.

6. The method according to claim 1,
wherein the polymer has a number average molecular weight of 12,000 or greater.

7. The method according to claim 1,
wherein the compressive fluid comprises carbon dioxide.

8. The method according to claim 4,
wherein the organic catalyst is a basic nucleophilic nitrogen compound.

9. The method according to claim 1,
wherein the ring-opening polymerizable monomer is a monomer having a ring structure comprising an ester bond therein.

10. The method according to claim 1,
wherein a lower limit of a temperature during the ring-opening polymerization in the bringing is lower than a melting point of the ring-opening polymerizable monomer by 50° C., and
an upper limit of the temperature during the ring-opening polymerization in the bringing is higher than the melting point of the ring-opening polymerizable monomer by 50° C.

11. The method according to claim 1,
wherein an upper limit of a temperature during the ring-opening polymerization in the bringing is 100° C.
